(19) United States
(12) Patent Application Publication
(10) Pub. No.: US 2017/0146990 A1
(43) Pub. Date: May 25, 2017

(54) AUGMENTED COMMUNICATION AND POSITIONING USING UNMANNED AERIAL VEHICLES

(71) Applicant: CATERPILLAR INC., Peoria, IL (US)

(72) Inventors: Qi WANG, Pittsburgh, PA (US); Paul Edmund RYBSKI, Pittsburgh, PA (US)

(73) Assignee: CATERPILLAR INC., Peoria, IL (US)

(21) Appl. No.: 14/945,659

(22) Filed: Nov. 19, 2015

(51) Int. Cl. G05D 1/00; G05D 1/10; G01S 19/42; B64C 39/02

(52) U.S. Cl. CPC G05D 1/0011; B64C 39/024; G05D 1/101; G01S 19/42; B64C 2201/024; B64C 2201/108; B64C 2201/122

(57) ABSTRACT

A system for augmenting wireless communication and satellite positioning for machines at a worksite includes one or more unmanned aerial vehicles (UAV) configured to be remotely operated above an area encompassing the worksite. Each of the UAV includes a real time kinematic (RTK) global positioning system (GPS) onboard the UAV for determining the position of the UAV relative to a base station located at a known location, and a machine vision module for detecting an object on the ground at the worksite. The RTK GPS onboard each UAV determines the global coordinates of the detected object in 3D space using the position of the UAV. A flight control module receives information on current position of one or more machines operating at the worksite, and machine wireless communication and satellite positioning requirements in real-time from the one or more machines, and controls flight of at least one UAV to a position where the at least one UAV can augment wireless communication signal and GPS satellite signal connectivity to meet the machine wireless communication and satellite positioning requirements.

### TECHNICAL FIELD

The present disclosure relates generally to augmented communication and positioning of mobile vehicles, and more particularly, to augmented communication and positioning of mobile vehicles using unmanned aerial vehicles.

### BACKGROUND

Terrain at a worksite commonly undergoes geographic alteration by machines through, for example, digging, grading, leveling, or otherwise preparing the terrain for various uses or removing material from the ground. Rough terrain, or other naturally-occurring or man-made geographical features, structural objects, and other stationary or mobile obstacles may interfere with reliable wireless communications and GPS signals used for accurate location and control of machines operating at the worksite. Some current solutions to the problem of “blind areas” or “dead zones” for wireless communications include deploying and maintaining multiple communication base stations. However, with the terrain and other potential obstacles constantly changing at a mine site, the existing solutions are expensive and time consuming. The complex terrains and other obstacles at a mine site or other worksite can also interfere with a clear line-of-sight between machines operating at the worksite and satellites needed for accurate location of the machines through GPS signals. Reliable, continuous, and accurate wireless communications and GPS signals for the machines are often very important for the safe and efficient operation of the machines, and particularly when the machines are being operated under remote and/or autonomous control.

One system intended for augmenting global positioning system (GPS) signals is described in U.S. Patent Application Publication No. 2014/0195150 (the '150 publication) to Rios. The '150 publication describes a system and method for augmenting GPS signals using a group of unmanned aircraft. Each of the aircraft in the '150 publication comprises a GPS antenna, a GPS receiver, and a GPS repeater. Each of the aircraft receives a GPS signal from a satellite and transmits within a defined geographic boundary a repeatable GPS signal.

Although the system of the '150 publication may improve the quality of GPS signals that are received by unmanned aircraft flying at stratospheric levels and then transmitted to various locations on earth, there is still room for improvement. The system of the '150 publication does not provide a means for also improving the reliability of wireless communications between machines and base stations operating on the ground, and for positioning the unmanned aircraft based on changing terrain and other obstacles on the ground, as well as the specific real-time needs of individual machines operating at a worksite, in order to maintain the best possible connectivity with individual mobile machines.

The disclosed system is directed to overcoming one or more of the problems set forth above and/or other problems of the prior art.

### SUMMARY OF THE INVENTION

In one aspect, the present disclosure is directed to a system for augmenting wireless communication and satellite positioning for machines at a worksite. The system may include one or more unmanned aerial vehicles (UAV) configured to be remotely operated above an area encompassing the worksite. Each of the UAV may include a real time kinematic (RTK) global positioning system (GPS) onboard the UAV for determining the position of the UAV relative to a base station located at a known location. Each of the UAV may further include a machine vision module configured to detect an object on the ground at the worksite. The RTK GPS onboard each UAV may further determine the global coordinates of the detected object in 3D space using the position of the UAV. Each UAV may be controlled by a flight control module configured to receive information on the current position of one or more machines operating at the worksite, and real-time machine wireless communication and satellite positioning requirements for the one or more machines, and control flight of the UAV to a position where the UAV can augment wireless communication signal and GPS satellite signal connectivity to meet the machine wireless communication and satellite positioning requirements.

In another aspect, the present disclosure is directed to a method for augmenting wireless communication and satellite positioning for machines at a worksite. The method may include remotely operating one or more unmanned aerial vehicles (UAV) above an area encompassing the worksite. The method may further include determining the position of each of the UAV relative to a base station in a known location using a real-time kinematic (RTK) global positioning system (GPS) onboard the UAV. The method may still further include detecting a mobile machine on the ground at the worksite using a machine vision module included onboard at least one of the UAV and determining the global coordinates of the detected mobile machine in 3D space relative to the position of the at least one UAV. The method may also include receiving at one or more of the UAV information on current machine position and machine wireless communication and satellite positioning requirements in real-time from one or more detected machines operating at the worksite, and controlling flight of at least one UAV to one or more positions where the at least one UAV can augment wireless communication signal and GPS satellite signal connectivity to meet the machine wireless communication and satellite positioning requirements.

In still another aspect, the present disclosure is directed to a non-transitory computer-readable medium for use in augmenting wireless communication and satellite positioning for machines at a worksite, the computer-readable medium comprising computer-executable instructions that, when executed by one or more computer processors, perform a method including remotely operating one or more unmanned aerial vehicles (UAV) above an area encompassing the worksite. The method may further include determining the position of each of the UAV relative to a base station in a known location using a real-time kinematic (RTK) global positioning system (GPS) onboard the UAV. The method may still further include detecting a mobile machine on the ground at the worksite using a machine vision module included onboard at least one of the UAV and determining the global coordinates of the detected mobile machine in 3D space relative to the position of the at least one UAV. The method may also include receiving at one or more of the UAV information on current machine position and machine wireless communication and satellite positioning requirements in real-time from one or more detected machines operating at the worksite, and controlling flight of at least one UAV to one or more positions where the at least one UAV can augment wireless communication signal and GPS satellite signal connectivity to meet the machine wireless communication and satellite positioning requirements.

### BRIEF DESCRIPTION OF THE DRAWINGS

FIG. 1 is a pictorial illustration of an exemplary worksite that will benefit from implementation of the disclosed system for augmenting wireless communication and satellite positioning for machines;

FIG. 2 is a pictorial illustration of an exemplary relationship between a UAV in accordance with implementations of this disclosure, a base station, and a plurality of mobile vehicles operating at a worksite; and

FIG. 3 is a pictorial illustration of another exemplary relationship between a UAV in accordance with implementations of this disclosure, a base station, and a plurality of mobile vehicles operating at a worksite.

### DETAILED DESCRIPTION

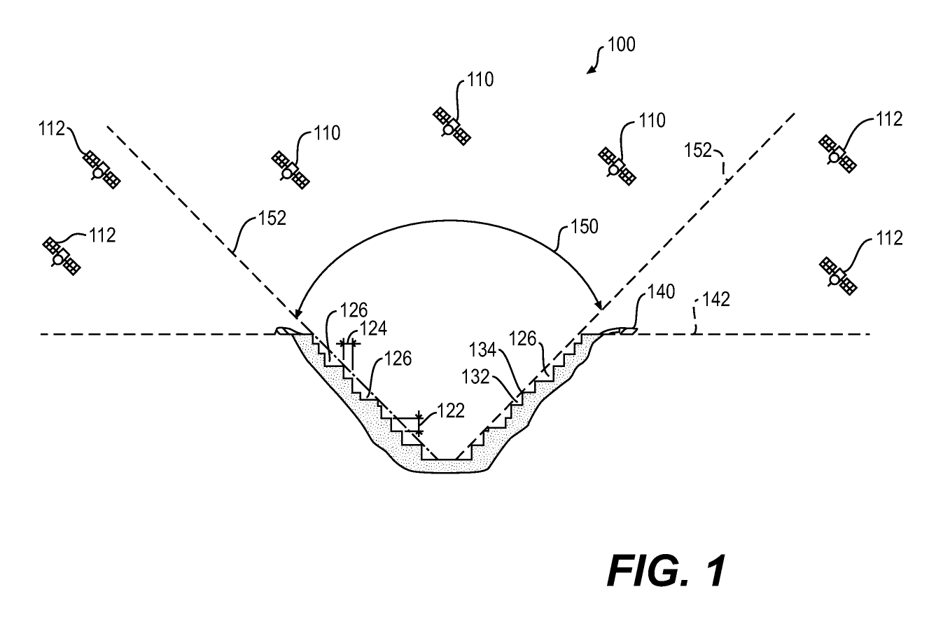

FIG. 1 illustrates an exemplary worksite 100 at which a plurality of mobile machines may be performing various tasks. The worksite 100 shown in FIG. 1 is an open pit mine. In various alternative implementations, the worksite 100 may include, for example, an open pit mine, a landfill, a quarry, a construction site, or any other type of worksite having terrain traversable by one or more mobile machines. The tasks being performed by the machines may be associated with altering the geography at the worksite 100, or building various structures, and may include a hauling operation, a grading operation, a leveling operation, a plowing operation, a bulk material removal operation, or any other type of operation. As each machine operates at the worksite 100, the shapes, dimensions, and general positions of the terrain and various structures may change.

In the illustrated example of an open pit mine, removal of material from the sides of the open pit mine may result in the creation of roads 126, which provide paths along which machines carrying the material removed from the sides of the pit may be transported out of the mine. As material is removed from the pit, benches having widths 124 and heights 122 may also be cut into the sides of the pit, with each bench extending from a toe 132 out to a crest 134 in a stepped arrangement up along the sides of the pit. For machines working at the bottom of the pit or along the benches cut into the sides of the pit, lines of sight 152 to open sky above the pit may be defined along the crests 134 of each bench, such that each machine operating in the pit may have a limited field of view 150 defined between the lines of sight 152. As a result, particularly for machines working at or near the bottom of the pit, satellites 112 used to provide GPS positioning information for the machines in the pit may be outside of the field of view 150. Accurate information on the real-time position of each machine may become at least temporarily unavailable when some satellites 112 are outside the field of view 150 at certain times of day, and only a limited number of satellites 110, or none at all, may be positioned in the sky over the pit within the field of view 150 for some or all of the machines operating in the pit.

As the open pit is continually mined for materials that are removed from the sides of the pit, the terrain inside the pit is constantly changing, and the lines of sight 152 and field of view 150 for receiving GPS signals from overhead satellites may also be changing for one or more of the machines operating in the pit. The terrain of the original surface 142 surrounding the pit may also include piles of unconsolidated overburden 140, or rocks and soil cleared away before the mining of the pit began. In addition to causing potentially unreliable or non-existent GPS signals for accurate positioning of the machines operating in the pit, the changing terrain may also result in unreliable wireless communication between the machines and one or more base stations that may be used for controlling individual machines and coordinating mine site operations.

Each of the machines operating at the worksite 100 may include sensors configured to determine one or more parameters of the machine and generate corresponding signals. The signals generated and transmitted from each machine may be indicative of operational parameters, machine health, machine productivity, machine pose, and other characteristics that may be relevant for autonomous control of the machine and for coordinated job site management. For example, sensors may include a position sensor configured to determine a position of the machine. The position sensor could embody, for example, a Global Positioning System (GPS) device, an Inertial Reference Unit (IRU), a local tracking system, or any other known position sensor that receives or determines positional information associated with the machine. In some embodiments, the positional information may be three-dimensional, although units providing only two-dimensional information may also be used. Sensors may also include an accelerometer configured to determine an acceleration of the machine. Sensors may further include a tilt sensor configured to detect a pitch and a roll of a frame of the machine. Additional sensors may include a load sensor configured to detect a payload of a work tool on the machine (i.e., a mass of material contained within and transported by the work tool).

Work tool sensors may embody any type of sensor configured to detect a position of the work tool relative to a known position on the machine, and generate a corresponding signal indicative thereof. Work tool sensors may also be configured to detect an operational state of each work tool (e.g., whether the work tool is engaged with a work surface). In one example, a work tool sensor may be an acoustic, magnetic, or optical type sensor associated with actuators and linkage that move the work tool, for example associated with a hydraulic ram, a rotary motor, or a joint. In another example, a work tool sensor may be a local and/or global positioning sensor configured to communicate with offboard devices (e.g., local laser systems, radar systems, unmanned aerial vehicles (UAV), satellites, etc.) to directly determine local and/or global coordinates of the work tool. Any number and type of work tool sensors may be included and positioned at any location on or near the work tools of each machine at the worksite 100. Based on signals generated by the work tool sensors and based on known kinematics of the work tools, one or more processors at the offboard devices may be configured to determine in real time a location of the associated work tool relative to the known position of the machine.

Each machine may also be equipped with a communicating device, which may include hardware and/or software that enables sending and receiving of data messages between an onboard controller and an offboard controller, such as may be located onboard one or more UAV and/or at a base station. The data messages may be sent and received via a direct data link and/or a wireless communication link, as desired. The direct data link may include an Ethernet connection, a connected area network (CAN), or another data link known in the art. The wireless communications may include satellite, cellular, infrared, and any other type of wireless communications that enable the communications device onboard each machine to exchange information between offboard controllers and the various components of systems and subsystems onboard each machine.

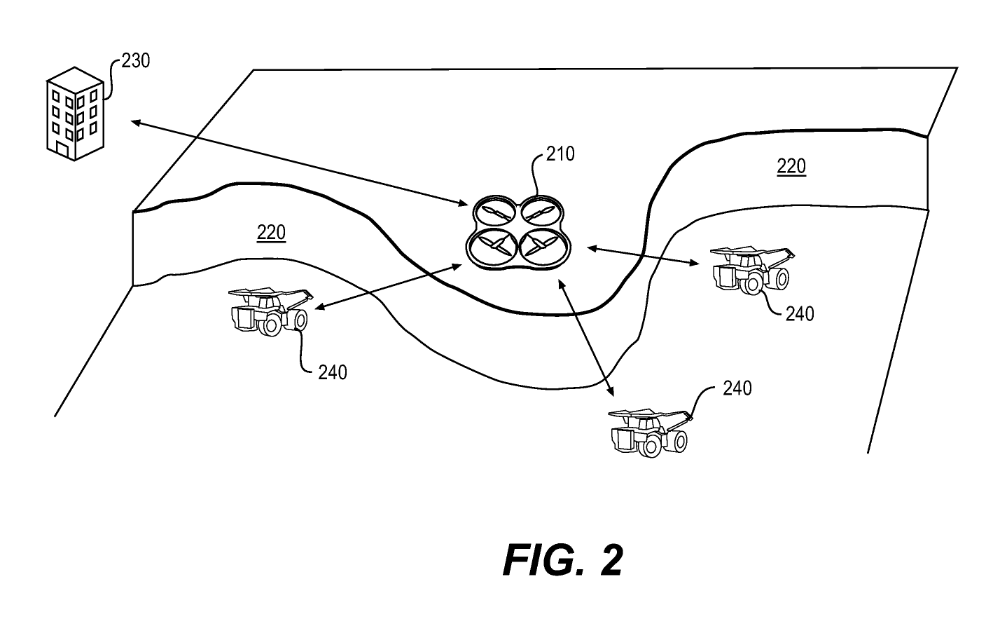

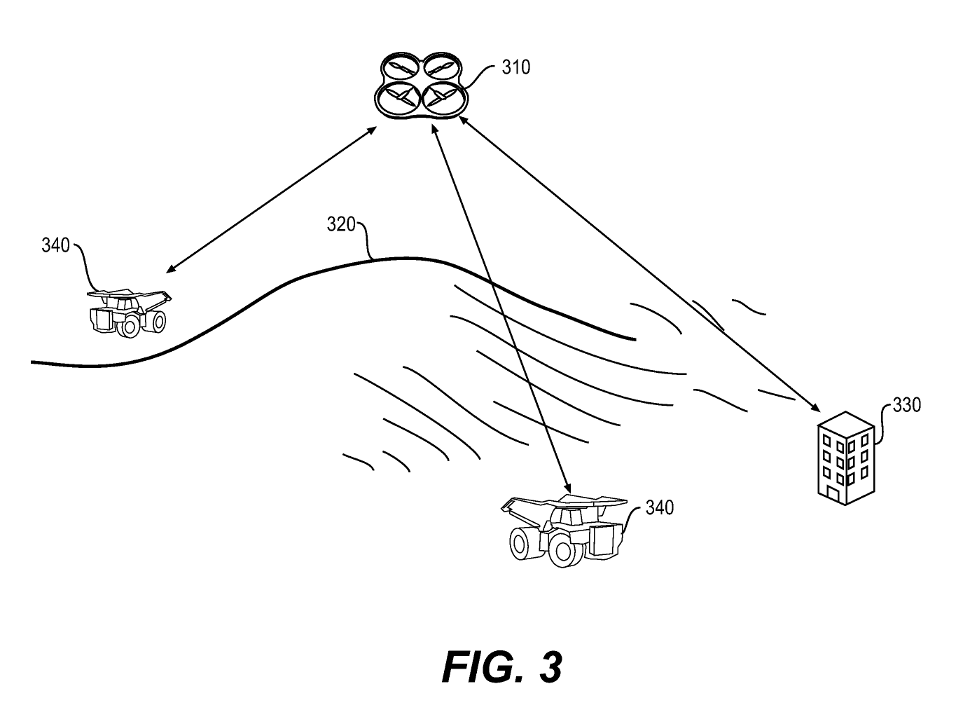

Referring to FIGS. 2 and 3, each of the machines 240, 340 may be operating over a variety of changing terrains at a worksite, including high walls 220, hills 320, or other geographic features or manmade structures. As a result of the changing terrain, various machines 240, 340 may be required to operate in areas where there is no clear line-of-sight between one machine and another machine, or between a machine and a base station 230, 330. This may result in the machines operating in “dead zones” or “blind spots” where wireless communication is unreliable, and where GPS signals from satellites may be at least temporarily unavailable at certain times of day. In accordance with various implementations of the present disclosure, one or more UAV 210, 310 may be provided and remotely controlled to assume a flight path near the worksite. In some implementations, an entire fleet of UAV may be operated over the worksite in order to ensure continuous, reliable wireless communication and satellite positioning for each of the machines. The provision of a fleet of UAV may provide the added benefit of allowing for refueling, recharging, repair, and other maintenance operations to be performed on some of the UAV while enough other UAV can remain in flight over the job site to ensure continuous, reliable wireless communications and machine position determination from GPS signals.

A flight controller, or one or more flight control modules included within a controller onboard each UAV, and/or located at one or more base stations 230, 330 and in wireless communication with flight control devices onboard the UAV may embody a single or multiple microprocessors, field programmable gate arrays (FPGAs), digital signal processors (DSPs), etc. The flight control devices onboard each UAV may include electric motors, solenoids, linkages, and other mechanisms for controlling the operation of propellers, ailerons, or other flight control surfaces on the UAV, and thereby controlling the direction, speed, and flight path of each UAV. Each of the UAV may also include a real time kinematic (RTK) global positioning system (GPS) onboard the UAV for accurately determining the position of the UAV relative to a base station located at a known location. Each of the UAV may further include a machine vision module configured to detect an object on the ground at the worksite.

The machine vision module may include an optical system mounted on each of the UAV in a position that may be controlled to provide an unobstructed line-of-sight from one or more cameras or other optical devices to an area encompassing one or more machines operating at a worksite. In some implementations the images captured by optical devices may be transmitted to an image processor that is part of the machine vision module onboard the UAV, or offboard the UAV to a back office or other location including one or more processors configured to perform image processing in accordance with various disclosed embodiments. The devices employed for capturing images of the machines may include one or more cameras or other sensors that capture images in visible wavelengths of light or radiation outside of the visible wavelengths of light. In various implementations, the optical system may be configured to transmit and receive visible light, infrared light, gamma radiation, X-rays, or any other form of electromagnetic radiation. The image processor onboard or offboard the UAV may be configured to receive the target images from the one or more sensors and analyze the target images. Analysis of the target images may include determining a feature set that characterizes the target image, such as known features of a particular machine operating at the worksite. The image processor may also be configured to retrieve a reference image from a memory. The reference image may include an image of the particular machine having dimensions or other visual characteristics that fall within known thresholds for that type of machine. A library of these reference images may be pre-recorded and stored in one or more memories, onboard the UAV, or offboard at a back office or other locations. The reference images may be obtained under a variety of different lighting conditions, environmental conditions, translational positions of the machine, or rotational positions or orientations of the machine. The library may be continually updated as new models of machines and new components are developed and placed into service at a worksite under a large variety of different circumstances and operating conditions.

The RTK GPS onboard each UAV may determine the global coordinates of the detected object, such as a machine 240, 340, or personnel, in 3D space using the position of the UAV. The one or more flight control modules onboard each UAV and/or located at a base station 230, 330 may be configured to receive information on current machine position and machine wireless communication and satellite positioning requirements in real-time from one or more detected machines 240, 340 operating at the worksite 100. A flight control module may be configured to control flight of the UAV to a position where the UAV can augment wireless communication signal and GPS satellite signal connectivity to meet the wireless communication and satellite positioning requirements of the one or more machines.

The one or more flight control modules may also be configured to generate and store a wireless communication coverage map and a satellite visibility map for a particular worksite. The flight control modules may alternatively or additionally be configured to continually or periodically update the wireless communication coverage map and satellite visibility map retrieved from memory as machines operating at the worksite change the terrain or otherwise affect lines of sight and fields of view for wireless communication and satellite visibility. In some embodiments, a controller onboard each UAV and/or offboard at a base station may also be configured to control operations of the machines in response to operator requests, built-in constraints, sensed operational parameters, and/or communicated instructions from a controller at the base station or other remote location. Numerous commercially available microprocessors can be configured to perform the functions of these components. Various known circuits may be associated with these components, including power supply circuitry, signal-conditioning circuitry, actuator driver circuitry (i.e., circuitry powering solenoids, motors, or piezo actuators), and communication circuitry.

Each of the plurality of UAV and/or one or more controllers at a base station may include any means for monitoring, recording, storing, indexing, processing, and/or communicating various operational aspects of the worksite 100 and any number of the machines. These means may include components such as, for example, a memory, one or more data storage devices, a central processing unit, or any other components that may be used to run an application. Furthermore, although aspects of the present disclosure may be described generally as being stored in memory, one skilled in the art will appreciate that these aspects can be stored on or read from different types of computer program products or computer-readable media such as computer chips and secondary storage devices, including hard disks, floppy disks, optical media, CD-ROM, or other forms of RAM or ROM.

Various implementations of the disclosed system provide a means for augmenting wireless communication and satellite positioning for machines at a worksite. The flight control modules located onboard each UAV, or offboard at a base station may be configured to receive information on current machine position, and machine wireless communication and satellite positioning requirements in real-time from one or more detected machines operating at the worksite. The controller onboard at least one UAV or offboard the UAV at a back office may be configured to identify the areas at the worksite where a machine is likely to experience unreliable wireless communication with another machine at a different location of the worksite. The identification of wireless communication problem areas may be based on at least one of an evaluation of current terrain or other obstacles positioned in between the two machines and information relating to real-time or historical wireless communication problems between machines located in the areas. The controller may also be configured to identify the areas at the worksite where a machine is likely to experience unreliable wireless communication with a base station at the worksite based on at least one of an evaluation of current terrain or other obstacles positioned in between the machine and the base station and information relating to real-time or historical wireless communication problems between one or more machines located in the areas and the base station.

The flight control module may be further configured to control flight of the at least one UAV to a position over an area identified as an area with unreliable wireless communication. The flight control module associated with a UAV may direct the UAV to the area with unreliable wireless communication when the machine vision module onboard the UAV detects a machine as being positioned in the area or moving toward the area. Additionally or in the alternative, the UAV may be directed to the area with unreliable wireless communication when the UAV, or back office controller in communication with the UAV receives information relating to a real-time wireless communication problem being experienced by a machine operating in the area.

At least one of the UAV may also be configured to determine and save a satellite visibility map identifying areas at the worksite where a machine is likely to experience unreliable connectivity with a GPS satellite. The at least one UAV may be configured to identify the areas at the worksite where a machine is likely to experience unreliable connectivity with a GPS satellite based on an evaluation of any terrain or other obstacles in the way of a clear line-of-sight between each of the areas and current known positions of GPS satellites at different times of day. The at least one UAV may also identify areas at the worksite with unreliable satellite connectivity based on information relating to real-time or historical problems with satellite connectivity for machines located in the areas.

The flight control module associated with each UAV may be further configured to control flight of the UAV to a position over an area identified as an area where a machine is likely to experience unreliable connectivity with a GPS satellite when the machine vision module detects a machine positioned in the area or moving toward the area. Additionally or in the alternative, the UAV may receive information in real-time relating to a satellite connectivity problem being experienced by a machine currently operating in the area. By directing one or more UAV to a position over an area where a machine is experiencing problems with wireless communication, each UAV may provide a communication relay between two machines at the worksite, and between a machine and a base station at the worksite. Each UAV may also augment satellite connectivity for machines operating at the worksite during different times of day. A UAV may fly at a high enough location over a machine lacking direct line-of-sight with a satellite in order to accurately determine the position of the UAV relative to a base station using RTK GPS onboard the UAV. The UAV may then determine accurate global coordinates for the machine based on the position of the UAV and broadcast the machine's global coordinates to the machine and/or to an offboard remote controller, such as may be located at a back office.

### INDUSTRIAL APPLICABILITY

The disclosed system and method uses one or more unmanned aerial vehicles (UAV) for augmenting wireless communication and satellite positioning for machines operating at a worksite. The one or more UAV may be remotely operated above an area encompassing the worksite. Using the one or more UAV in accordance with various implementations of this disclosure provides a solution to unreliable wireless communication between machines and between machines and base stations at a worksite, and low quality satellite positioning information that may result from terrain changes at the worksite. Reliable wireless communication and high quality GPS positioning signals are important for enabling computer-guided machine operations, for monitoring machine health, productivity, and performance, and for implementing optimal fleet management protocols.

The flight paths of each of the UAV may be planned and controlled as a function of the most useful location for each UAV to benefit the mobile machines working at a mine site or other worksite. Each of the UAV may be provided with information on which of the machines at the worksite needs augmentation of wireless communication signals and/or satellite positioning signals when operating at different locations at the worksite. The UAV may then be controlled through the use of flight control modules onboard the UAV or offboard the UAV at a base station in communication with flight control devices on the UAV. The position of each of the one or more UAV may be determined relative to a base station in a known location using a real-time kinematic (RTK) global positioning system (GPS) located onboard the UAV. Each UAV may also detect a mobile machine on the ground at the worksite using a machine vision module included onboard the UAV, and determine the global coordinates of the detected mobile machine in 3D space relative to the position of the at least one UAV. The one or more UAV controlled in accordance with various implementations of this disclosure are able to position themselves to most effectively provide quality wireless communication signal and satellite positioning signal connectivity for the machines. The UAV may be controlled in the most effective and efficient manner to benefit the machines as they operate in a continually changing terrain and around potentially changing obstacles, infrastructure, personnel, and work paths.

Flight path control for each of the UAV may be based on real-time information and signals indicative of current machine position and machine wireless communication and satellite positioning requirements from one or more detected machines operating at the worksite. The flight control modules in accordance with various implementations of this disclosure control flight of at least one UAV to one or more positions where the at least one UAV can augment wireless communication signal and GPS satellite signal connectivity to meet the machine wireless communication and satellite positioning requirements. The controllers onboard or offboard the UAV may also determine and save a wireless communication coverage map identifying areas at the worksite where a machine is likely to experience at least one of unreliable wireless communication with another machine at a different location of the worksite and unreliable wireless communication with a base station at the worksite. Identification of the areas at the worksite where a machine is likely to experience unreliable wireless communication with another machine at a different location of the worksite may be based on at least one of an evaluation of current terrain or other obstacles positioned in between the two machines and information relating to real-time or historical wireless communication problems between machines located in the areas. Identification of the areas at the worksite where a machine is likely to experience unreliable wireless communication with a base station at the worksite may be based on at least one of an evaluation of current terrain or other obstacles positioned in between the machine and the base station and information relating to real-time or historical wireless communication problems between one or more machines located in the areas and the base station. Flight path control for a UAV may result in flying the UAV to a position over an area identified as an area with unreliable wireless communication when the machine vision module onboard the UAV detects a machine as being one of positioned in the area or moving toward the area. Alternatively or in addition, the UAV may receive information relating to a real-time wireless communication problem being experienced by a machine operating in the area.

The controllers onboard or offboard one or more UAV may also determine and save a satellite visibility map identifying areas within the worksite where a machine is likely to experience unreliable connectivity with a GPS satellite. Identification of the areas within the worksite where a machine is likely to experience unreliable connectivity with a GPS satellite may be based on at least one of an evaluation of any terrain or other obstacles in the way of a clear line-of-sight between each of the areas and current known positions of GPS satellites at different times of day, and information relating to real-time or historical problems with satellite connectivity for machines located in the areas. Flight path control may result in flying at least one UAV to a position over an area identified as an area where a machine is likely to experience unreliable connectivity with a GPS satellite when the machine vision module detects a machine as being one of positioned in the area or moving toward the area. Alternatively or in addition, the at least one UAV may receive information relating to a real-time satellite connectivity problem being experienced by a machine operating in the area. The one or more UAV employed in accordance with various implementations of this disclosure enable dynamic mapping of constantly changing terrains and other worksite features, and use this information along with information on the position of each of the machines and personnel operating at the worksite at any point in time to best position the one or more UAV for improved wireless communication and satellite positioning connectivity.

It will be apparent to those skilled in the art that various modifications and variations can be made to the disclosed system and methods. Other embodiments will be apparent to those skilled in the art from consideration of the specification and practice of the disclosed system. It is intended that the specification and examples be considered as exemplary only, with a true scope being indicated by the following claims and their equivalents.

What is claimed is:

1. A system for augmenting wireless communication and satellite positioning for machines at a worksite, the system comprising:
one or more unmanned aerial vehicles (UAV) configured to be remotely operated above an area encompassing the worksite, wherein each of the UAV includes:
a real time kinematic (RTK) global positioning system (GPS) onboard the UAV configured for determining the position of the UAV relative to a base station located at a known location;
a machine vision module configured for detecting an object on the ground at the worksite; and
the RTK GPS onboard each UAV being configured for determining the global coordinates of the detected object in 3D space using the position of the UAV; and
a flight control module configured to receive information on current position of one or more machines operating at the worksite, and machine wireless communication and satellite positioning requirements in real-time from the one or more machines, and control flight of at least one UAV to a position where the at least one UAV can augment wireless communication signal and GPS satellite signal connectivity to meet the machine wireless communication and satellite positioning requirements.

2. The system of claim 1, wherein at least one of the one or more UAV is further configured to determine and save a wireless communication coverage map identifying wireless communication problem areas at the worksite where a machine is likely to experience at least one of unreliable wireless communication with another machine at a different location of the worksite and unreliable wireless communication with a base station at the worksite.

3. The system of claim 2, wherein the at least one UAV is configured to identify the areas at the worksite where a machine is likely to experience unreliable wireless communication with another machine at a different location of the worksite based on at least one of an evaluation of current terrain or other obstacles positioned in between the two machines and information relating to real-time or historical wireless communication problems between machines located in the areas.

4. The system of claim 2, wherein the at least one UAV is configured to identify the areas at the worksite where a machine is likely to experience unreliable wireless communication with a base station at the worksite based on at least one of an evaluation of current terrain or other obstacles positioned in between the machine and the base station and information relating to real-time or historical wireless communication problems between one or more machines located in the areas and the base station.

5. The system of claim 2, wherein the flight control module is further configured to control flight of the at least one UAV to a position over an area identified as an area with unreliable wireless communication when at least one of:
the machine vision module detects a machine as being one of positioned in the area or moving toward the area; and
the at least one UAV receives information relating to a real-time communication problem being experienced by a machine operating in the area.

6. The system of claim 1, wherein at least one of the one or more UAV is further configured to determine and save a satellite visibility map identifying areas at the worksite where a machine is likely to experience unreliable connectivity with a GPS satellite.

7. The system of claim 6, wherein the at least one UAV is configured to identify the areas at the worksite where a machine is likely to experience unreliable connectivity with a GPS satellite based on at least one of an evaluation of any terrain or other obstacles in the way of a clear line-of-sight between each of the areas and current known positions of GPS satellites at different times of day, and information relating to real-time or historical problems with satellite connectivity for machines located in the areas.

8. The system of claim 6, wherein the flight control module is further configured to control flight of the at least one UAV to a position over an area identified as an area where a machine is likely to experience unreliable connectivity with a GPS satellite when at least one of:
the machine vision module detects a machine as being one of positioned in the area or moving toward the area; and
the at least one UAV receives information relating to a real-time satellite connectivity problem being experienced by a machine operating in the area.

9. The system of claim 1, wherein at least one of the one or more UAV is configured to provide a communication relay between two machines at the worksite and between a machine and a base station at the worksite.

10. A method for augmenting wireless communication and satellite positioning for machines at a worksite, the method comprising:
remotely operating one or more unmanned aerial vehicles (UAV) above an area encompassing the worksite;
determining the position of each of the one or more UAV relative to a base station in a known location using a real-time kinematic (RTK) global positioning system (GPS) located onboard the UAV;
detecting a mobile machine on the ground at the worksite using a machine vision module included onboard at least one of the one or more UAV;
determining the global coordinates of the detected mobile machine in 3D space relative to the position of the at least one UAV;
receiving at one or more of the UAV information on current machine position and machine wireless communication and satellite positioning requirements in real-time from one or more detected machines operating at the worksite; and
controlling flight of at least one UAV to one or more positions where the at least one UAV can augment wireless communication signal and GPS satellite signal connectivity to meet the machine wireless communication and satellite positioning requirements.

11. The method of claim 10, further including:
determining and saving a wireless communication coverage map identifying areas at the worksite where a machine is likely to experience at least one of unreliable wireless communication with another machine at a different location of the worksite and unreliable wireless communication with a base station at the worksite.

12. The method of claim 11, further including:
identifying the areas at the worksite where a machine is likely to experience unreliable wireless communication with another machine at a different location of the worksite based on at least one of an evaluation of current terrain or other obstacles positioned in between the two machines and information relating to real-time or historical wireless communication problems between machines located in the areas.

13. The method of claim 11, further including:
identifying the areas within the worksite where a machine is likely to experience unreliable wireless communication with a base station at the worksite based on at least one of an evaluation of current terrain or other obstacles positioned in between the machine and the base station and information relating to real-time or historical wireless communication problems between one or more machines located in the areas and the base station.

14. The method of claim 11, further including:
controlling flight of the at least one UAV to a position over an area identified as an area with unreliable wireless communication when at least one of:
the machine vision module detects a machine as being one of positioned in the area or moving toward the area; and
the at least one UAV receives information relating to a real-time communication problem being experienced by a machine operating in the area.

15. The method of claim 10, further including:
determining and saving a satellite visibility map identifying areas within the worksite where a machine is likely to experience unreliable connectivity with a GPS satellite.

16. The method of claim 15, further including:
identifying the areas within the worksite where a machine is likely to experience unreliable connectivity with a GPS satellite based on at least one of an evaluation of any terrain or other obstacles in the way of a clear line-of-sight between each of the areas and current known positions of GPS satellites at different times of day, and information relating to real-time or historical problems with satellite connectivity for machines located in the areas.

17. The method of claim 15, further including:
controlling flight of the at least one UAV to a position over an area identified as an area where a machine is likely to experience unreliable connectivity with a GPS satellite when at least one of:
the machine vision module detects a machine as being one of positioned in the area or moving toward the area; and
the at least one UAV receives information relating to a real-time satellite connectivity problem being experienced by a machine operating in the area.

18. A non-transitory computer-readable medium for use in augmenting wireless communication and satellite positioning for machines at a worksite, the computer-readable medium comprising computer-executable instructions that, when executed by one or more computer processors, perform a method comprising:
remotely operating one or more unmanned aerial vehicles (UAV) above an area encompassing the worksite;
determining the position of each of the one or more UAV relative to a base station in a known location using a real-time kinematic (RTK) global positioning system (GPS) onboard the UAV;
detecting a mobile machine on the ground at the worksite using a machine vision module included onboard at least one of the UAV;
determining the global coordinates of the detected mobile machine in 3D space relative to the position of the at least one UAV;
receiving at one or more of the UAV information on current machine position and machine wireless communication and satellite positioning requirements in real-time from one or more detected machines operating at the worksite; and
controlling flight of the at least one UAV to one or more positions where the at least one UAV can augment wireless communication signal and GPS satellite signal connectivity to meet the machine wireless communication and satellite positioning requirements.

19. The non-transitory computer-readable medium of claim 18, wherein the method further includes:
determining and saving a wireless communication coverage map identifying areas at the worksite where a machine is likely to experience at least one of unreliable wireless communication with another machine at a different location of the worksite and unreliable wireless communication with a base station at the worksite.

20. The non-transitory computer-readable medium of claim 19, wherein the method further includes:
identifying areas within the worksite where a machine is likely to experience unreliable connectivity with a GPS satellite based on at least one of an evaluation of any terrain or other obstacles in the way of a clear line-of-sight between each of the areas and current known positions of GPS satellites at different times of day, and information relating to real-time or historical problems with satellite connectivity for machines located in the areas; and
controlling flight of the at least one UAV to a position over an area identified as an area where a machine is likely to experience unreliable connectivity with a GPS satellite when at least one of:
the machine vision module detects a machine as being one of positioned in the area or moving toward the area; and
the at least one UAV receives information relating to a real-time satellite connectivity problem being experienced by a machine operating in the area.
